(19) United States
(12) Patent Application Publication
(10) Pub. No.: US 2007/0068749 A1
(43) Pub. Date: Mar. 29, 2007

(54) Apparatus and method for actuating a parking brake of a vehicle

(76) Inventors: Peter Ullmann, Burgberg (DE); Christoph Kasper, Sonthofen (DE); Harald Guggenmos, Immenstadt/Seifen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/525,946

(22) Filed: Sep. 25, 2006

(30) Foreign Application Priority Data
Sep. 29, 2005 (DE) 10 2005 046 607.9

(51) Int. Cl. F16D 65/36

(52) U.S. Cl. 188/156

(57) ABSTRACT

A parking brake for a vehicle, including a brake unit for immobilizing a wheel of the vehicle and an activation unit for activating the brake unit, in which an actuator, which is already present in the vehicle and has at least one other function, is able to actuate the activation unit in order to activate the brake unit.

### CROSS REFERENCE TO RELATED APPLICATIONS

This application is based on German Patent Application No. 10 2005 046 607.9 filed on 29 Sep. 2005, upon which priority is claimed.

### BACKGROUND OF THE INVENTION

1. Field of the Invention

The present invention relates to a parking brake for a vehicle, which is used in particular in vehicles with automated parking brakes. The present invention also relates to a method for actuating a parking brake of a vehicle.

2. Description of the Prior Art

A wide variety of designs of parking brakes are known from the prior art. In addition to the known cable hand brakes, recently, power-assisted automated parking brakes have come into use, in which the driver uses a button or switch, for example, to indicate the desired parking brake setting and the parking brake is then automatically activated or deactivated. In this context, it is known to execute the driver's parking braking request by means of small electric drive units, for example, provided directly in the wheels. Automated parking brakes of this kind, however, are relatively complex and expensive in design. In addition, automated parking brakes are known in which hydraulic pressure is used to immobilize the vehicle. Such parking brakes, however, are also relatively complex and expensive in design.

### OBJECT AND SUMMARY OF THE INVENTION

The parking brake for a vehicle according to the present invention has the advantage over the prior art that it has a simple, inexpensive design, with a minimum number of components. This also makes it possible to reduce the weight of the vehicle. This is achieved according to the present invention by virtue of the fact that an activation unit for activating a brake unit is activated by means of an actuator that is already present in the vehicle. In other words, an actuator is used, which already has another function in the vehicle and additionally assumes the function of actuating the activation unit for the parking brake. This makes it possible to eliminate an additional electric motor as a drive unit for the activation unit or a complex hydraulic system for driving the activation unit.

The actuator that is already present in the vehicle is preferably the starter of the engine. This makes the parking brake according to the present invention particularly inexpensive to produce. The starter has the particular advantage of being an electric motor with a high power density. Normally, the starter is used only for starting the engine's internal combustion engine. It is therefore available for other functions in the vehicle with no loss in convenience.

It is also preferable to integrate a control unit for the parking brake into a control unit that is already present in the vehicle. The control unit can, for example, be integrated into an existing service brake control unit for brake systems that are already present in the vehicle, e.g. ABS, ESP, TCS, etc. This can be easily achieved because the parking brake requires only control functions that do not in turn require high switching currents.

In order to permit the actuator to be disconnected or uncoupled from the activation unit of the parking brake, a clutch is preferably provided between the actuator and the activation unit. The clutch makes it possible to engage or disengage a connection between the actuator and the activation unit of the parking brake.

According to another preferred embodiment of the present invention, the activation unit includes a spring-type brake actuator that actuates the parking brake. The spring-type brake actuator is prestressed by the actuator that is already integrated into the vehicle. The use of the spring-type brake actuator also has the advantage that it permits an automatic temperature compensation to occur. It also assures a simple, rugged construction. The actuator can prestress the spring-type brake actuator, independent of the time at which an actuation of the parking brake is required. In this connection a sensor is provided to notify the control unit of the prestressing force remaining in the spring-type brake actuator so that the control unit can reload the spring-type brake actuator as needed by operating the actuator.

Preferably, the spring-type brake actuator includes a first spring element and the activation unit also includes a piston, a locking device for locking a parking brake position, and an actuation element for actuating the brake unit. The actuation element is preferably a cable.

Preferably, the locking device includes a retaining disk, a magnetic coil, a second spring element, and a plate. The second spring element in this case prestresses the plate against the retaining disk.

The retaining disk is preferably provided with a sleeve that is situated so that it can rotate in relation to the piston.

According to a preferred embodiment of the present invention, the sleeve has a linkage element that is engaged by an engaging device that is prestressed by means of a third spring element. The engaging device here is provided on the piston. The sleeve and the piston are thus connected to each other in a manner that assures their ability to rotate in relation to one another.

The linkage element is situated in the sleeve in such a way that it has a predetermined inclination. The inclination here can be constant or can change along the circumference of the sleeve. Preferably, though, the inclination is constant in order to assure a constant movement speed during activation of the parking brake.

In order to assure a resetting of the activation unit of the parking brake for a releasing of the parking brake, a third spring element is also provided, which is connected to the retaining disk and returns the retaining disk to its starting position. Consequently, when the parking brake is actuated, this prestresses the third spring element, which is subsequently used for the resetting action when the parking brake is released.

The piston also preferably has a central cylindrical part on which the engaging device is provided in order to engage in the linkage element.

The central cylindrical part of the piston is preferably also provided with a connecting device for connecting the piston to the actuating element of the brake unit. The connecting device between the piston and the actuating element is preferably comprised of two or more balls, which can be brought into and out of engagement through relative rotation of the sleeve in relation to the piston with the actuating element.

The present invention also relates to a method for actuating a parking brake of a vehicle in which the parking brake is activated by means of a spring-type brake actuator. At least one spring-type brake actuator is prestressed by means of an actuator provided in the vehicle, in particular a starter. This allows the method to be executed in a particularly simple, inexpensive fashion.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 shows a schematic sectional view of the parking brake according to the present invention, with an actuator that is integrated into the vehicle,

FIG. 2 shows a schematic sectional view of an activation unit for a parking brake according to one exemplary embodiment of the present invention,

FIG. 3 shows a side view of a sleeve according to the exemplary embodiment shown in FIG. 2, and

FIG. 4 shows a top view of a retaining disk according to the exemplary embodiment shown in FIG. 2.

### DESCRIPTION OF THE PREFERRED EMBODIMENTS

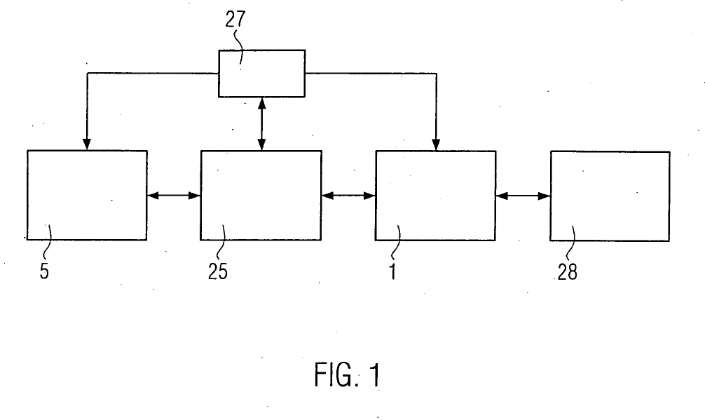

An exemplary embodiment of the present invention will be described in detail below in conjunction with FIGS. 1 through 4.

FIG. 1 shows the schematic structure of the parking brake according to the present invention. The parking brake includes a brake unit 28, e.g. a drum brake, an activation unit 1, a clutch 25, and an actuator 5, which, in this exemplary embodiment, is a starter of the vehicle. The clutch 25 is situated between the actuator 5 and the activation unit 1 and engages and disengages a connection between the actuator 5 and the activation unit 1. A control unit 27 sends the clutch 25 the signals required for this. The control unit 27 also controls the starter and the activation unit 1 (see FIG. 1).

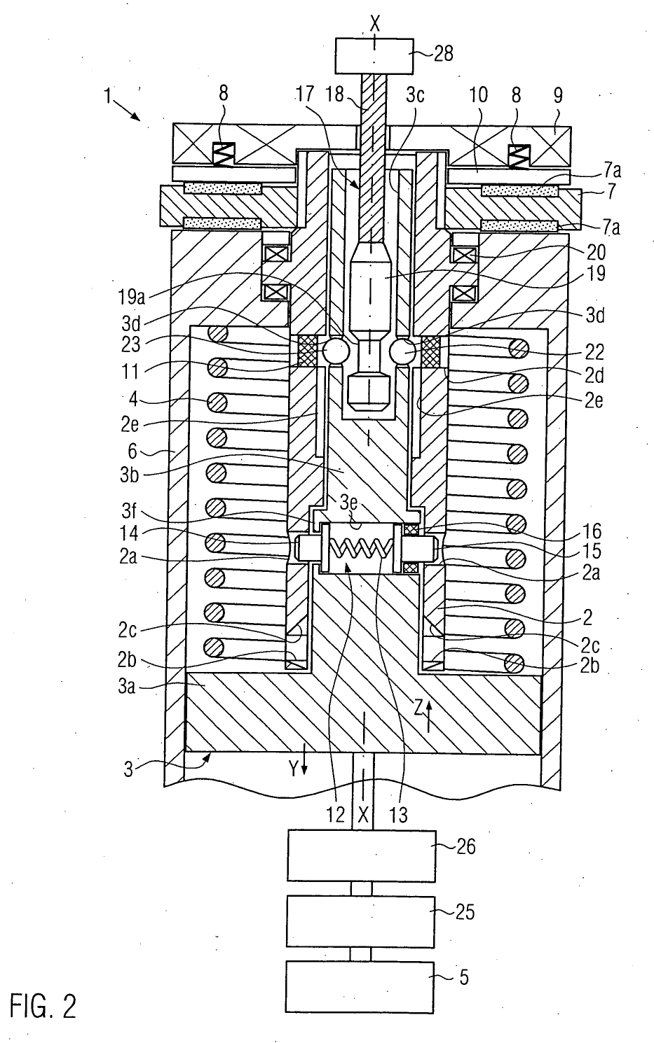

FIG. 2 shows a sectional view of the activation unit 1 according to the present invention. An actuation device 17 connects the activation unit 1 to the brake unit 28 in order to immobilize a vehicle wheel.

As shown in FIG. 2, the activation unit 1 includes a piston 3, which is contained in a housing 6. The piston 3 includes a piston bottom 3a and a central cylindrical part 3b. Between the piston 3 and a housing bottom, a first spring element 4 is provided. The first spring element 4 is embodied in the form of a cylinder spring. The piston bottom 3a is connected to the actuator 5 via a spindle unit 26 and the clutch 25. When the clutch 25 is in the engaged state, the actuator 5 can drive the spindle unit 26 so that the piston 3 moves in the direction of the arrow Z in order to prestress the activation unit 1.

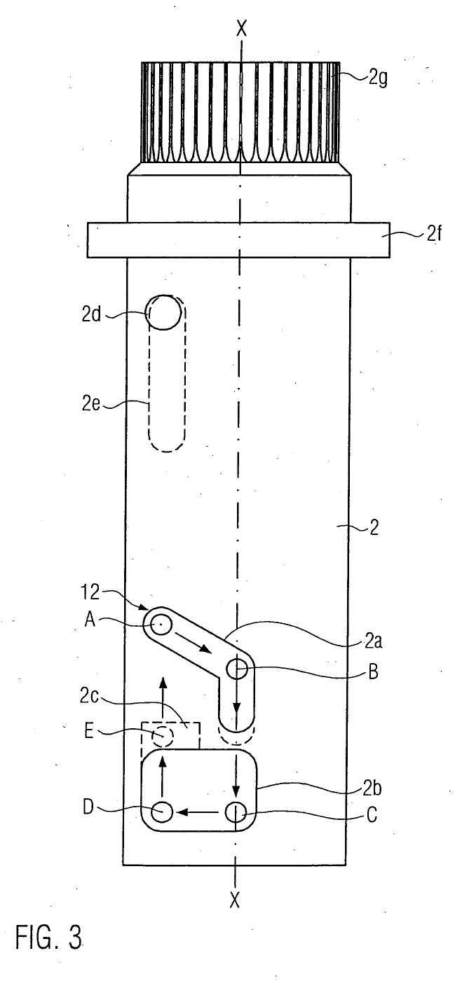

The activation unit 1 also includes a sleeve 2, which is embodied essentially in the form of a hollow cylinder and is situated around the cylindrical part 3b of the piston 3. The sleeve 2 is shown in the detail in FIG. 3 and has a first linkage element 2a, a second linkage element 2b, and a ramping bevel 2c provided on the second linkage element 2b (see FIG. 2). The sleeve 2 also has a circular recess 2d adjoined by a groove 2e extending perpendicularly downward on the inner circumference of the sleeve. An outwardly protruding collar 2f is also provided to permit the sleeve 2 to be supported in rotary fashion on a bearing 20. The upper end region of the sleeve 2 is also provided with an external gearing 2g.

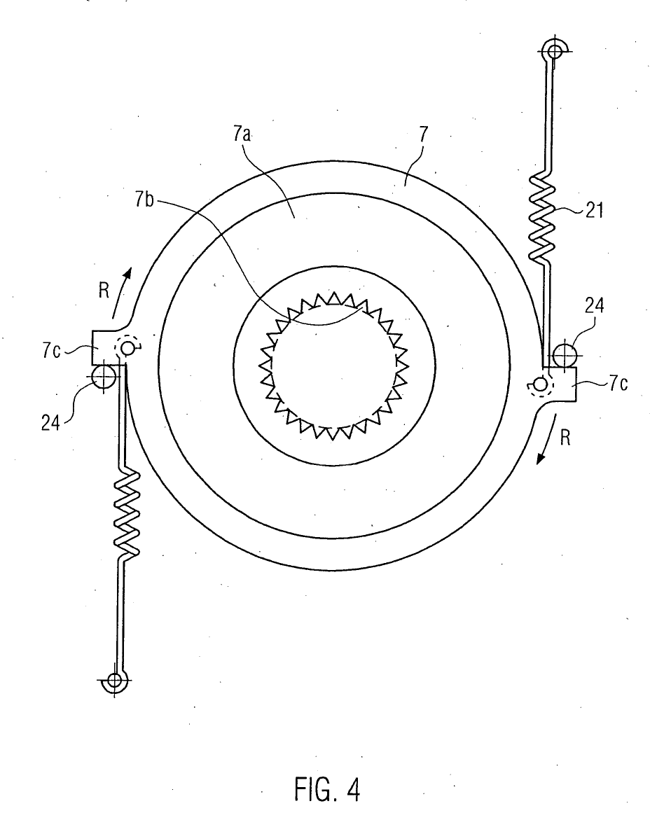

The activation unit 1 also has a locking device. The locking device has a retaining plate 7, a second spring element 8, a magnetic coil 9, and an intermediate plate 10. The retaining plate 7 is an annular plate, the opposite sides of which are provided with respective annular friction linings 7a. FIG. 4 shows a top view of the retaining plate 7. The retaining plate 7 likewise has a gearing 7b along an internal recess or opening. The gearing 7b engages with the gearing 2g of the sleeve 2 so that the retaining plate 7 and the sleeve 2 are connected to each other in a form-locked manner. The sleeve 2 and the retaining plate 7 are thus connected so that they are unable to rotate in relation to each other but do have the ability to move in the axial direction X-X in relation to each other. An outwardly protruding stop 7c is also provided on the outer circumference of the retaining plate 7. The second spring element 8 is situated on the magnetic coil 9 and attached to the intermediate plate 10. The second spring element 8 presses the intermediate plate 10 downward, thus prestressing it away from the magnetic coil 9. In other words, the second spring element 8 presses the intermediate plate 10 against the retaining plate 7, thus permitting the sleeve 2 to be locked in position. In this instance, the retaining plate 7 can move relative to the sleeve 2 in the axial direction X-X of the activation unit 1 by means of the gearings 2e and 7b.

The sleeve 2 is connected to the piston 3 by means of an engaging device 12, as also shown in FIG. 2. The engaging device 12 includes a third spring element 13 as well as a first nipple 14 and second nipple 15. The engaging device 12 is accommodated in a lateral bore 3e in the cylindrical part 3b of the piston. The lateral bore 3e is embodied in the form of a through bore; one end of the lateral bore is embodied as a stop 3f for the first nipple 14. The other end of the lateral bore 3e is closed by means of an installation ring 16, which in a similar fashion, constitutes a stop for the second nipple 15. The engaging device 12 here engages with the linkage elements 2a and 2b in the sleeve 2. The linkage elements 2a and 2b are shown in the detail in FIGS. 2 and 3. A first part of the linkage element 2a is embodied as inclined in relation to a longitudinal direction X-X of the sleeve 2 so that a movement of the engaging device 12 produces a relative rotation between the piston 3 and the sleeve 2. The magnitude of the relative movement is determined by the inclination of the first part of the linkage element 2a. The second part of the linkage element 2a is embodied as parallel to the longitudinal direction. The second linkage element 2b is situated essentially at right angles to a ramping bevel 2c.

As is clear from FIG. 2, the actuation device 17 for actuating the parking brake, not shown, includes a cable 18 with an end piece 19. The cable 18, together with the end piece 19, is situated in a bore 3c of the piston 3. The end piece 19 is embodied as an essentially cylindrical part and has an annular groove 19a. In the non-actuated state, the annular groove 19a is situated at the level of a through bore 3d in the cylindrical part 3b of the piston 3. A connecting device is also provided for connecting the piston 3 to the actuation device 17. The connecting device has a first and second ball 22, 23. The first and second balls 22, 23 are accommodated in the through bore 3d. The balls 22, 23 are designed to engage in the groove 19a of the end piece 19 and are able to produce a connection between the piston 3 and the actuation device 17 when they are moved inward toward the end piece 19.

A fourth spring element 21 comprised of two spiral springs is also attached to the retaining plate 7 in order to automatically return the retaining plate 7 into its starting position (as shown in FIG. 4). In the starting position, the stops 7c rest against the elements 24.

The function of the activation unit 1 according to the present invention will be described below. A driver activates the parking brake (parking brake) of the vehicle by actuating a switch or button. This sends the control unit 27 a signal and supplies current to the magnetic coil 9. As a result, the magnetic coil 9 pulls the intermediate plate 10 toward the magnetic coil 9 in opposition to the spring force of the second spring element 8. This releases the retaining plate 7, which the spring force of the second spring element 8 locked in place when the magnetic coil was not actuated. As a result, the retaining plate 7 can now rotate.

Since the retaining plate 7 is connected to the sleeve 2 in a form-locked fashion, the sleeve 2 is also now released and the first spring element 4 can move the piston 3 in the direction of the arrow Y. Since the piston 3 is connected to the sleeve 2 by means of the engaging device 12, the inclination of the first linkage element 2a causes the sleeve 2, together with the retaining plate 7, to rotate in relation to the piston 3. The movement of the engaging device 12 is labeled more precisely by the letter sequence A, B, C, D, E in FIG. 3. In a first step, the engaging device 12 travels from the starting point A along the first linkage element 2a to point B and then perpendicularly, in the longitudinal direction of the sleeve 2. Starting from point B, the sleeve 2 no longer rotates in relation to the piston 3. By means of a ramp, not shown, the engaging device 12—or more precisely stated, its first and second nipple 14, 15—travels into the second linkage element 2b until reaching position C, causing the nipples 14, 15 to be pressed inward counter to the spring force of the third spring element 13. The relative rotation of the sleeve 2 in relation to the piston 3 causes the securing plate 7 to also rotate counter to the spring force of the fourth spring element 21, which is indicated by the arrows R in FIG. 4.

As is particularly clear in FIG. 2, the relative rotation of the sleeve 2 in relation to the piston 3 also actuates the actuation device 17 by means of ramping bevels, not shown, in such a way that the two balls 22, 23 are moved inward into the groove 19a of the end piece 19 of the actuation device 17. This attaches the piston 3 to the cable 18, which is in turn connected to the brake unit 28. Consequently, when the piston 3 moves in the direction of the arrow Y, the cable 18 is also simultaneously pulled in the direction of the arrow Y, thus activating the parking brake. The connection between the cable 18 and the piston 3 is produced immediately when a relative rotation of the sleeve 2 occurs in relation to the piston 3.

After the parking brake is activated, the current to the magnetic coil 9 is switched off again so that the second spring element 8 presses the intermediate plate 10 against the retaining plate 7 and locks the activation unit 1 in place. This locks the parking brake in the braking position.

The parking brake is thus activated only by the spring force generated by the spring-type brake actuator embodied in the form of the first spring element 4.

In order to release the parking brake, the driver actuates a button or switch again so that a control unit 17 once again supplies the magnetic coil 9 with current. This releases the locking of the retaining plate 7 since the magnetic coil 9 pulls the intermediate plate 10 counter to the spring force of the second spring element 8. The fourth spring elements 21 on the retaining plate 7, which are prestressed during the activation of the parking brake, can therefore relax again, causing a renewed relative rotation of the retaining plate 17 together with the sleeve 2 in relation to the piston 3. This moves the engaging device 12 from point C to point D into the second linkage device 2d (see FIG. 3). As is also clear from FIG. 2, the points A and D are situated on a line parallel to the longitudinal axis X-X of the sleeve 2 so that at this point, the balls 22, 23 are disengaged once more from the end piece 19. As a result, the balls 22, 23 can be moved back into the through bore 3d so that the actuating device 17 is once again free and the parking brake is thus released. Then the supply of power to the magnetic coil 9 is once again switched off so that the retaining plate 7 and the sleeve 2 are once again locked in position.

In order to enable an additional parking braking action, the spring-type brake actuator of the activation unit 1, i.e. the first spring element 4, must be prestressed again. To this end, the clutch 25 is brought into its engaged position and the starter provided as the actuator 5 is actuated so that the piston 3 is moved in the direction of the arrow Z via the clutch 25 and the spindle unit 26. The piston 3 is consequently moved in the direction toward the magnetic coil 9, counter to the spring force of the first spring element 4. The nipples 14, 15 of the engaging device 12 first move from point D to point E. At point E, the nipples 14, 15 are pressed inward into the housing 2 by the ramping bevel 2c and are consequently retracted from point E to point A parallel to the longitudinal axis of the sleeve 2. The third spring element 13 is compressed almost completely as a result so that the nipples 14, 15 are retracted completely into the bore 3e. This returns the apparatus to the starting position A and prestresses the parking brake for a subsequent use.

According to the present invention, an actuator 5 that is already present in the vehicle is thus able to engage and release the parking brake of the vehicle. According to the present invention, it is also not necessary to readjust the stress in response to temperature changes since the elasticity of the spring elements provides for a temperature compensation. When the starter is used to prestress the spring element 4, this makes a parking brake particularly inexpensive to produce. This also makes it possible to keep the total number of components of the parking brake to a minimum. The spring-type brake actuator can therefore be loaded at any time, independent of a brake-engaging action.

The foregoing relates to preferred exemplary embodiments of the invention, it being understood that other variants and embodiments thereof are possible within the spirit and scope of the invention, the latter being defined by the appended claims.

We claim:

1. In a parking brake for a vehicle, including a brake unit for immobilizing a wheel of the vehicle and an activation unit for activating the brake unit, the improvement wherein an actuator that is already present in the vehicle and has at least one other function is operable to actuate the activation unit in order to activate the brake unit.

2. The parking brake according to claim 1, wherein the actuator is the starter of the vehicle's engine.

3. The parking brake according to claim 1, further comprising a control unit for the parking brake, the control unit for the parking brake being integrated into a control unit that is already present in the vehicle.

4. The parking brake according to claim 2, further comprising a control unit for the parking brake, the control unit for the parking brake being integrated into a control unit that is already present in the vehicle.

5. The parking brake according to claim 1, further comprising a clutch between the actuator and the activation unit, the clutch being operable to engage or disengage a connection between the actuator and the activation unit.

6. The parking brake according to claim 1, wherein the activation unit comprises a spring-type brake actuator operable to actuate the parking brake and the actuator is able to actuate the spring-type brake actuator.

7. The parking brake according to claim 4, wherein the activation unit comprises a spring-type brake actuator operable to actuate the parking brake and the actuator is able to actuate the spring-type brake actuator.

8. The parking brake according to claim 6, wherein the spring-type brake actuator comprises a first spring element, and wherein the activation unit includes a piston, a locking device, and an actuation device that is connectable to the piston and is operable for actuating the brake unit.

9. The parking brake according to claim 8, wherein the locking device comprises a retaining disk, a magnetic coil, a second spring element, and an intermediate plate, and wherein the second spring element prestresses the intermediate plate against the retaining disk.

10. The parking brake according to claim 9, wherein the retaining disk is attached to a sleeve, and wherein the sleeve is rotatable in relation to the piston.

11. The parking brake according to claim 10, wherein the sleeve comprises a linkage element that is engaged by an engaging device that is prestressed by means of a third spring element and is situated on the piston.

12. The parking brake according to claim 9, wherein the linkage element of the sleeve has a predetermined inclination in relation to the longitudinal axis of the sleeve.

13. The parking brake according to claim 10, wherein the linkage element of the sleeve has a predetermined inclination in relation to the longitudinal axis of the sleeve.

14. The parking brake according to claim 9, further comprising a fourth spring element operable to return the retaining disk to its starting position.

15. The parking brake according to claim 8, wherein the piston comprises a piston bottom, and wherein a central cylindrical part and the engaging device is situated in the cylindrical part in order to engage with the linkage element of the sleeve.

16. The parking brake according to claim 15, further comprising a connecting device on the cylindrical part of the piston for connecting the piston to an actuating device of the parking brake.

17. The parking brake according to claim 16, wherein the connecting device includes two balls, which a relative rotation of the sleeve in relation to the piston is able to bring into engagement with an end piece of the actuation device in order to connect the piston to the actuation device.

18. The parking brake according to claim 16, wherein the actuation device comprises an end piece with an annular groove.

19. The parking brake according to claim 17, wherein the actuation device comprises an end piece with an annular groove.

20. A method for actuating a parking brake of a vehicle, the method comprising activating the parking brake exclusively by means of the spring force of a spring-type brake actuator, and prestressing the spring-type brake actuator by means of an actuator that is already present in the vehicle, in particular a starter.
